(19) United States
(12) Patent Application Publication
(10) Pub. No.: US 2021/0274133 A1
(43) Pub. Date: Sep. 2, 2021

(54) PRE-GENERATING VIDEO EVENT NOTIFICATIONS

(71) Applicant: ObjectVideo Labs, LLC, Tysons, VA (US)

(72) Inventors: Donald Gerard Madden, Columbia, MD (US); Ethan Shayne, Clifton Park, NY (US)

(21) Appl. No.: 17/177,634

(22) Filed: Feb. 17, 2021

Related U.S. Application Data
(60) Provisional application No. 62/982,898, filed on Feb. 28, 2020.

(51) Int. Cl. H04N 7/18; G06K 9/00; H04N 5/232

(52) U.S. Cl. CPC H04N 7/188; G06K 9/00671; G06K 9/00771; H04N 5/232941; H04N 5/23222

(57) ABSTRACT

Methods, systems, and apparatus for pre-generating video event notifications are disclosed. A method includes obtaining images of a scene from a camera; determining that an event is likely to occur at a particular time based on the obtained images; in response to determining that the event is likely to occur at the first time, generating an instruction that triggers a user device to provide an alert to a user of the user device at the particular time; and providing the instruction to the user device. Providing the instruction to the user device includes providing alert data and an instruction to pre-cache the alert data until the particular time. The alert data includes at least one of: the obtained images; notification text to be displayed; a classification of an object identified in the images; the particular time that the event is likely to occur; or a classification of the event.

### CROSS-REFERENCE TO RELATED APPLICATIONS

This application claims the benefit of the U.S. Provisional Patent Application No. 62/982,898 filed Feb. 28, 2020, which is incorporated herein by reference in its entirety.

### TECHNICAL FIELD

This disclosure application relates generally to surveillance cameras.

### BACKGROUND

Many properties are equipped with monitoring systems that include sensors and connected system components. Some property monitoring systems include cameras.

### SUMMARY

Techniques are described for pre-generating video event notifications.

Many residents and homeowners equip their properties with monitoring systems to enhance the security, safety, or convenience of their properties. A property monitoring system can include cameras that can obtain visual images of scenes at a property. In some examples, a camera can be incorporated into another component of the property monitoring system, e.g., a doorbell camera.

A camera can detect objects and track object movement within a field of view. Objects can include, for example, humans, vehicles, and animals. Objects may be moving or stationary. Certain movements and positions of objects can be considered events. For example, an event can include an object crossing a virtual line crossing within a camera scene. An event can also include an object loitering in the field of view for a particular amount of time, or an object passing through the field of view a particular number of times.

In some examples, events detected by a camera can trigger a property monitoring system to perform one or more actions. For example, detections of events that meet pre-programmed criteria may trigger the property monitoring system to send a notification to a user, e.g., a resident of the property, or to adjust a setting of the property monitoring system. It is desirable that a camera quickly and accurately detect events in order to send timely notifications to the resident. In some examples, notifications can be sent to a user device of the resident, e.g., a smart phone, laptop, electronic tablet, or wearable device such as a smart watch.

When a monitoring system provides a notification in response to detecting a camera event, there may be a time delay, or latency, between the event occurring and the notification being provided. For example, the time delay may be due to time required for analyzing camera images, determining that an event occurred, generating the notification, transmitting the notification, receiving the notification, and displaying the notification.

Timeliness of notifications can be improved by pre-caching notification data on the user device before an event occurs. For example, if the monitoring system predicts that an event is likely to occur, the monitoring system can send a pre-alert to the user device before the time of the event. The pre-alert can include data related to the expected event, e.g., an expected time of the event, video images of the object, notification text to be displayed, identification of the object, etc. Upon receiving the pre-alert, the user device can cache the data from the pre-alert. When the user device receives the pre-alert, the pre-alert may be transparent to the user, e.g., the user device can cache the received data without providing any indication to the user.

After sending the pre-alert, the monitoring system can continue to analyze camera data to determine if the event will no longer occur, does occur, or does not occur. If the event occurs, the monitoring system can determine to take no action. The user device can then automatically provide the notification to the resident at the expected time of the event. The notification can include, for example, the notification text and video images of the object.

If the monitoring system determines that the event does not occur or will no longer occur, the monitoring system can determine to send an alert cancellation to the user device. In response to receiving the alert cancellation, the user device can cancel the alert, and therefore not provide the notification to the resident. If the monitoring system determines that the event does not occur, but is still expected to occur, the monitoring system can determine to send a delay command to the user device. The user device can then delay providing the notification until a new estimated time of event, or until receiving a command from the monitoring system to provide the notification. If the monitoring system determines that the event will occur at an earlier time than the expected time of the event, the monitoring system can determine to send a command to the user device to provide the notification at the earlier time.

Sending the pre-alert to the user device can reduce latency of providing notifications. When the user device displays a notification based on the pre-alert, the user device can retrieve the cached data, e.g., the video images of the object, and quickly display the data. Thus, the user device can provide the notification to the resident at approximately the same time as the event occurs. The resident can view the notification, including any video images, without experiencing a delay due to time required for transmitting and receiving data.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for pre-generating video event notifications for a predicted event that occurs.

FIG. 2 illustrates an example system for pre-generating video event notifications for a predicted event that does not occur.

FIG. 3 is a flow diagram of an example process for pre-generating video event notifications.

FIG. 4 is a diagram illustrating an example of a home monitoring system.

Like reference numbers and designations in the various drawings indicate like elements.

### DETAILED DESCRIPTION

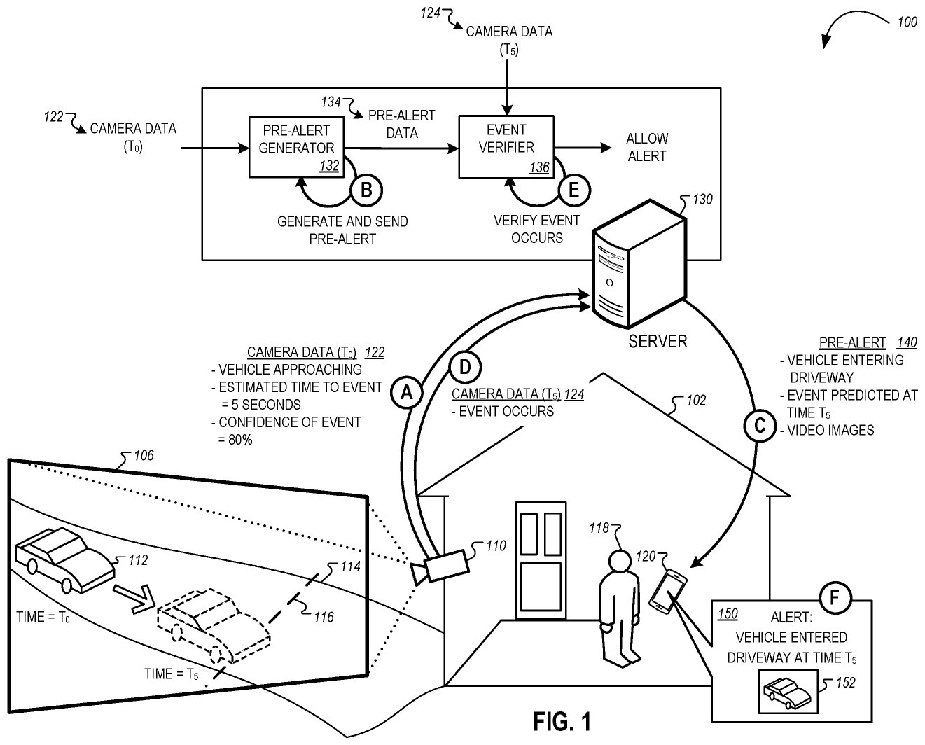

FIG. 1 illustrates an example system 100 for pre-generating video event notifications for a predicted event that occurs. The system 100 includes a camera 110, installed at a property 102, a remote server 130, and a mobile device 120 associated with a resident 118. The property 102 can be a home, another residence, a place of business, a public space, or another facility that has one or more cameras installed and is monitored by a property monitoring system.

The camera 110 is installed external to the property 102, facing a driveway 114 of the property 102. The camera 110 is positioned to capture images within a field of view that includes a region of the driveway 114. The camera 110 can record image data, e.g., video, from the field of view. In some implementations, the camera 110 can be configured to record continuously. In some implementations, the camera 110 can be configured to record at designated times, such as on demand or when triggered by another sensor at the property 102.

The monitoring server 130 can be, for example, one or more computer systems, server systems, or other computing devices. In some examples, the monitoring server 130 is a cloud computing platform. In some examples, the monitoring server 130 may communicate directly with the camera 110.

The camera 110 can communicate with the monitoring server 130 via a long-range data link. The long-range data link can include any combination of wired and wireless data networks. For example, the camera 110 may exchange information with the monitoring server 130 through a wide-area-network (WAN), a cellular telephony network, a cable connection, a digital subscriber line (DSL), a satellite connection, or other electronic means for data transmission. The camera 110 and the monitoring server 130 may exchange information using any one or more of various communication synchronous or asynchronous protocols, including the 802.11 family of protocols, GSM, 3G, 4G, 5G, LTE, CDMA-based data exchange or other techniques.

In some implementations, the camera 110 and/or the monitoring server 130 can communicate with the mobile device 120, possibly through a network. The mobile device 120 may be, for example, a portable personal computing device, such as a cellphone, a smartphone, a tablet, a laptop, or other electronic device. In some examples, the mobile device 120 is an electronic home assistant or a smart speaker.

In FIG. 1, the camera 110 captures video 106. The video 106 includes image frames of a vehicle 112 driving on the driveway 114, approaching the property 102. The video 106 includes multiple image frames captured over time. For example, the video 106 includes image frames captured at time T₀, images frames captured at time T₅, and images frames captured between time T₀ and time T₅, where time T₅ is five seconds after time T₀. The image frames of the video 106 show an outdoor scene of a vehicle 112 driving on the driveway 114.

The camera 110 may perform video analysis on the video 106. Video analysis can include detecting, identifying, and tracking objects in the video 106. Objects can include, for example, people, vehicles, and animals. Video analysis can also include determining if an event occurs. An event can include, for example, an object crossing a virtual line crossing, e.g., virtual line crossing 116. The virtual line crossing 116 can a virtual line positioned such that an object crossing the virtual line crossing indicates an event that may be of interest to the resident 118. For example, the vehicle 112 crossing the virtual line crossing 116 can represent the vehicle 112 entering the driveway 114. In another example, a virtual line crossing can be positioned at an edge of a front porch of a property. A person crossing the virtual line crossing can indicate an event of the person entering the porch. In some examples, an event might not involve a virtual line crossing, and may include an object loitering near the property 102 for a certain period of time, or passing by the property 102 a certain number of times.

FIG. 1 illustrates a flow of data, shown as stages (A) to (F), which represent steps in an example process. Stages (A) to (F) may occur in the illustrated sequence, or in a sequence that is different from the illustrated sequence. For example, some of the stages may occur concurrently.

In stage (A) of FIG. 1, the monitoring server 130 receives camera data 122 captured at time T₀. The camera 110 can send the camera data 122 to the monitoring server 130 over the long-range data link. The camera data 122 in FIG. 1 includes images of the vehicle 112 approaching the virtual line crossing 116 on the driveway 114. In some examples, the camera data 122 can include clips of the video 106. In some examples, the camera 110 can select image frames of the video 106 to send to the monitoring server 130. For example, the camera 110 can select image frames that include an object, e.g., the vehicle 112, to send to the monitoring server 130. In some examples, the camera 110 can send a live stream of the video 106 to the monitoring server 130, e.g., a live stream of image frames that may start at or before time T₀ and end at or after the time T₅.

In some examples, the camera 110 can perform video analysis on the video 106, and can send results of the video analysis to the monitoring server 130. For example, the camera 110 can determine through video analysis that the vehicle 112 is approaching the virtual line crossing 116. The camera data 122 can then send a message to the monitoring server 130 indicating that the vehicle 112 is approaching the virtual line crossing 116. The camera 110 may send the message to the monitoring server 130 in addition to, or instead of, the image frames of the video 106.

The camera data 122 can include an estimated time of a predicted event, e.g., an estimated time that the vehicle 112 will cross the virtual line crossing 116. The estimated time of the event can be based on a position of the vehicle 112 at time T₀, an estimated speed of the vehicle 112, a direction of the vehicle 112, and a position of the virtual line crossing 116. In FIG. 1, the estimated time of the event is T₅, or five seconds after T₀.

The camera data 122 can include a confidence value of the event occurring. The confidence value can indicate the likelihood, based on analyzing the available data, that the event will occur. For example, the camera data 122 can include a confidence value that the vehicle 112 will cross the virtual line crossing 116, a confidence that the vehicle 112 will cross the virtual line at time T₅, or both. In FIG. 1, the camera data 122 includes a confidence value of 80% that the vehicle 112 will cross the virtual line crossing 116.

In some examples, the confidence value may vary depending on a classification of the detected object. For example, a vehicle moving along a street in a particular direction is likely to continue moving in the same particular direction. In contrast, direction of human or animal movement may be less predictable. Therefore, the camera data 122 may include a higher confidence value for events related to vehicle movement, and a lower confidence value for events related to human or animal movement.

In some examples, the camera 110 can analyze the camera data 122 by performing object recognition on the video 106. For example, the camera 110 can analyze the video 106 to determine a make and model of the vehicle 112, a color of the vehicle 112, or a license plate of the vehicle 112.

The camera 110 may adjust the confidence value of the event based on object recognition. For example, the camera 110 may include a machine algorithm that enables the camera 110 to learn to recognize objects that appear frequently within the field of view. For example, the vehicle 112 may belong to a particular resident of the property 102, and may therefore frequently enter the driveway 114 of the property 102. Over time, the camera 110 can learn to identify the vehicle 112 as being associated with the particular resident of the property 102. When the camera 110 detects the vehicle 112, based on recognizing the vehicle 112 as being associated with the particular resident of the property 102, the camera 110 may raise the confidence of the virtual line crossing event, e.g., from 80% to 90%.

The camera 110 may continue to send camera data to the monitoring server 130 after sending the camera data 122. For example, the camera 110 may send the camera data 122 based on images captured at time T₀, and then may send camera data based on images captured at time T₁, T₂, etc., where time T₁ occurs one second after time T₀, and time T₂ occurs two seconds after time T₀. As the camera 110 continues to send camera data to the monitoring server 130, the camera 110 can send an updated estimated time to event and an updated confidence of event. For example, as the vehicle 112 approaches the virtual line crossing 116, the camera 110 can reduce the estimated time to the event, and raise the confidence of the event.

In stage (B) of FIG. 1, the monitoring server 130 generates a pre-alert 140. The monitoring server 130 can include a pre-alert generator 132 that analyzes the camera data 122 and generates a pre-alert 140 based on the camera data 122. The pre-alert 140 can include one or more predictions of near future activity based on the camera data 122.

The pre-alert generator 132 can determine whether to send the pre-alert 140 to the mobile device 120. In some examples, the pre-alert generator 132 can determine whether to send the pre-alert 140 based on the confidence value. For example, the pre-alert generator 132 may be programmed with a threshold confidence value. When the confidence value of the event exceeds the threshold confidence value, the pre-alert generator 132 can determine to send the pre-alert 140. The threshold confidence value may be a fixed value, or may be a value that updates over time, for example, based on accuracy of pre-alerts.

To update the threshold confidence value, the monitoring server 130 may evaluate accuracy of pre-alerts 140 sent to the mobile device 120 over time. For example, a pre-alert 140 that results in a notification being provided to a user at the expected time of event may be classified as an accurate pre-alert. A pre-alert 140 that results in an alert cancellation, or that results in a notification being provided to a user at an earlier or later time than the expected time of event, may be classified as an inaccurate pre-alert. A pre-alert 140 that results in an alert cancellation that is not received in time to prevent the notification from being provided to the user may also be classified as an inaccurate pre-alert.

In some examples, the monitoring server 130 may update the threshold confidence value in response to receiving feedback from a user, e.g., the resident 118. For example, a pre-alert 140 may result in a notification being provided to the resident 118 for an event that does not occur. In another example, a pre-alert 140 might not be sent for an event that does occur, resulting in a delayed notification being provided, or no notification being provided. The resident 118 may provide feedback to the monitoring system indicating that the notifications were inaccurate. The monitoring server 130 may then classify the respective pre-alerts as inaccurate pre-alerts.

Based on evaluating accuracy of pre-alerts 140 over time, the monitoring server 130 can adjust the threshold confidence value. For example, the monitoring server 130 may raise the threshold confidence value in order to reduce inaccurate pre-alerts that result in alert cancellations and notifications for events that do not occur. The monitoring server 130 may lower the threshold confidence value in order to reduce inaccurate pre-alerts that result in delayed notifications and events that occur without a notification being provided.

An example confidence value may be eighty percent, and an example threshold confidence value may be fifty percent. Since the confidence value exceeds the threshold confidence value, the pre-alert generator 132 can determine to send the pre-alert 140 to the mobile device 120. If the confidence value were less than the threshold confidence value, the pre-alert generator 132 may determine not to send the pre-alert 140, or may determine to wait to send the pre-alert 140 until the confidence value exceeds the threshold confidence value.

The pre-alert generator 132 can determine to which device to send the pre-alert 140. For example, two or more mobile devices may be registered with the monitoring system and associated with the property 102. In some examples, multiple users may be registered to the monitoring system, and each mobile device may be associated with an individual user. An individual user, e.g., the resident 118, may adjust preferences and settings of the system 100 using a user interface, e.g., presented through the mobile device 120. The preferences and settings can include a preference for a specific mobile device that should receive the pre-alert 140 and any following alerts. For example, the resident 118 can provide a selection into the user interface that the monitoring server 130 should send the pre-alert 140 to the mobile device 120, to another device associated with the property 102, or both. The pre-alert generator 132 can then determine to send the pre-alert 140 to the selected device.

In some examples, in addition to or instead of sending the pre-alert 140 to the mobile device 120, the pre-alert generator 132 can determine to send the pre-alert 140 to a third party device, e.g., a computing system of a third party security provider. The pre-alert generator 132 may determine to send the pre-alert 140 to the third party device based on settings of the system 100. For example, settings may include that pre-alerts 140 for certain types of events are sent to the third party device and the mobile device 120, while pre-alerts 140 for other types of events are only sent to the mobile device 120.

The pre-alert generator 132 can determine when to send the pre-alert 140 to the mobile device 120. In some examples, the pre-alert generator 132 can determine when to send the pre-alert 140 based on the estimated time to event. For example, the pre-alert generator 132 may be programmed with a threshold time to event. When the estimated time to event is less than the threshold time to event, the pre-alert generator 132 can determine to send the pre-alert 140.

An example estimated time to event may be five seconds, and an example threshold time to event may be six seconds. Since the estimated time to event is less than the threshold time to event, the pre-alert generator 132 may determine to send the pre-alert 140 to the mobile device 120 immediately. If the estimated time to event were greater than the threshold time to event, e.g., eight seconds, the pre-alert generator 132 may determine to wait until the estimated time to event is six seconds before sending the pre-alert 140.

In some examples, the pre-alert generator 132 can determine to send the pre-alert 140 to the mobile device 120 based on a coincidence between the confidence value and the estimated time to event. For example, the pre-alert generator 132 may determine to send the pre-alert 140 in response to the confidence value being greater than the threshold confidence, and the estimated time to event being less than the threshold time to event.

The pre-alert generator 132 can determine content of the pre-alert 140 to send to the mobile device 120. For example, the pre-alert generator 132 can determine content of the pre-alert 140 based on available data, the estimated time to event, a network bandwidth available, an expected latency of sending the pre-alert 140 to the mobile device 120, and storage space available on the mobile device 120.

The pre-alert generator 132 can determine content of the pre-alert 140 based on available data. The available data may include a camera image captured at time T₀ and camera images prior to time T₀. For example, the available data may include the camera image captured at time T₀, and fifteen seconds of video prior to time T₀, where the fifteen seconds of video may include images of the vehicle 112 entering the field of view of the camera 110.

The pre-alert generator 132 can determine content of the pre-alert 140 based on the estimated time to event. For example, the pre-alert generator 132 may determine to send a smaller amount of data for a smaller estimated time to event, since there is less time available for transmitting and receiving the data. The pre-alert generator 132 may determine to send a larger amount of data for a larger estimated time to event, since there is more time available for transmitting and receiving the data. For example, if the estimated time to event is five seconds, the pre-alert generator 132 may determine to send a small amount of data, e.g., including a single camera image or no camera image. If the estimated time to event is ten seconds, the pre-alert generator 132 may determine to send a large amount of data, e.g., including fifteen seconds of video images captured prior to time T₀.

The pre-alert generator 132 can determine content of the pre-alert 140 based on an expected latency of sending the pre-alert 140 to the mobile device 120. In order to determine the expected latency of the sending the pre-alert 140 to the mobile device 120, the monitoring server 130 may periodically send a test signal to the mobile device 120. In response to receiving the test signal, the mobile device 120 can send a reply signal to the monitoring server 130. Based on a timestamp of the reply signal, the monitoring server 130 can determine the expected latency of sending the pre-alert to the mobile device 120.

In some examples, the monitoring server 130 may use a machine learning method to learn over time the expected latency for different connectivity statuses of the mobile device 120. For example, the monitoring server 130 may determine that when the mobile device 120 is connected to a Wi-Fi network, the latency of sending the pre-alert 140 is a certain length of time, while when the mobile device 120 is not connected to a Wi-Fi network, the latency of sending the pre-alert 140 is a different length of time.

In some examples, the pre-alert generator 132 may store status data of the mobile device 120. The monitoring server 130 can receive status data from the mobile device 120, e.g., over the long-range data link. Status data can include, for example, a location of the mobile device 120, network connectivity of the mobile device 120, and storage availability of the mobile device 120. The monitoring server 130 can receive the status data from the mobile device 120, e.g., periodically, continuously, or in response to a status change. For example, the mobile device 120 may send the status data to the monitoring server 130 once per hour, or in response to the mobile device 120 connecting to or disconnecting from a network, e.g., a Wi-Fi network.

The pre-alert generator 132 can determine content of the pre-alert 140 based on a bandwidth available for transmitting the pre-alert 140 to the mobile device 120. For example, the mobile device 120 may have a larger bandwidth when connected to a Wi-Fi network than when not connected to a Wi-Fi network. The pre-alert generator 132 can determine to send a larger amount of content when the mobile device 120 has a larger bandwidth available, and a smaller amount of content when the mobile device 120 has a smaller bandwidth available.

In some examples, the pre-alert generator 132 can select a network for sending the pre-alert 140. For example, the mobile device 120 may be connected to a faster Wi-Fi network and to a slower cellular network. The pre-alert generator 132 may select to send the pre-alert 140 via the Wi-Fi network when faster speed is desired, such as when the expected time of the event is sooner, e.g., within a few seconds. The pre-alert generator 132 may select to send the pre-alert 140 via the cellular network when slower speed is acceptable, such as when the expected time of the event is later, e.g., more than a few seconds. In some examples, the pre-alert generator 132 may select a slower network in order to save cost and/or power. Since sending the pre-alert 140 reduces latency of notification by pre-caching alert data, the pre-alert generator 132 may be able to send the pre-alert 140 over the slower network without causing a delay in providing the timely notification.

In some examples, the pre-alert generator 132 may determine to send the pre-alert 140 to the mobile device 120 with video. The video can include images captured by the camera 110 that include the vehicle 112. In some examples, the pre-alert generator 132 can determine to send a still image to the mobile device 120, e.g., the image captured by the camera 110 at time T₀. In some examples, the pre-alert generator 132 can determine to send a notification text to the mobile device 120, without sending camera images.

In the example of FIG. 1, the pre-alert generator 132 may determine that the available content includes fifteen seconds of video prior to time T₀. The estimated time to event may be five seconds. Based on mobile device status data, the pre-alert generator 132 may determine that the mobile device 120 is likely not able to receive fifteen seconds of video from the monitoring server 130 in less than five seconds. Therefore, the pre-alert generator 132 can determine to send a smaller amount of data to the mobile device 120. For example, the pre-alert generator 132 can determine to send the pre-alert 140 with a shorter video. The shorter video may include only the portion of the fifteen seconds of video that shows the vehicle 112, or only a portion of the fifteen seconds of video in which the vehicle 112 is displayed clearly, e.g., in high resolution. In some examples, the pre-alert generator 132 may determine to send the pre-alert 140 with a single image, or no image, to the mobile device 120. In some examples, the pre-alert generator 132 may compress the video before sending the video to the mobile device 120.

In stage (C) of FIG. 1, the monitoring server 130 sends the pre-alert 140 to the mobile device 120. When the mobile device 120 receives the pre-alert 140, the mobile device 120 does not display the pre-alert. Rather, the mobile device 120 can cache the pre-alert for later display to the resident 118, e.g., for providing to the resident 118 at the estimated time of the event.

The pre-alert 140 can include the predicted event, and an expected time of the predicted event. For example, the pre-alert 140 can include the predicted event of the vehicle crossing the virtual line crossing 116 and thus entering the driveway 114. The pre-alert can include the expected time of event T₅. The pre-alert 140 may include a prepared notification text related to the event. For example, the prepared notification text may state “Vehicle Entered Driveway at Time T₅.” In some examples, the notification text can identify that the vehicle is a familiar vehicle. For example, if the monitoring server 130 recognized the vehicle 112 as being associated with a resident named Tommy, the text notification may state “Tommy's Vehicle Entered Driveway at Time T₅.” The pre-alert 140 can also include camera images, e.g., video, compressed video, or still images of the vehicle 112.

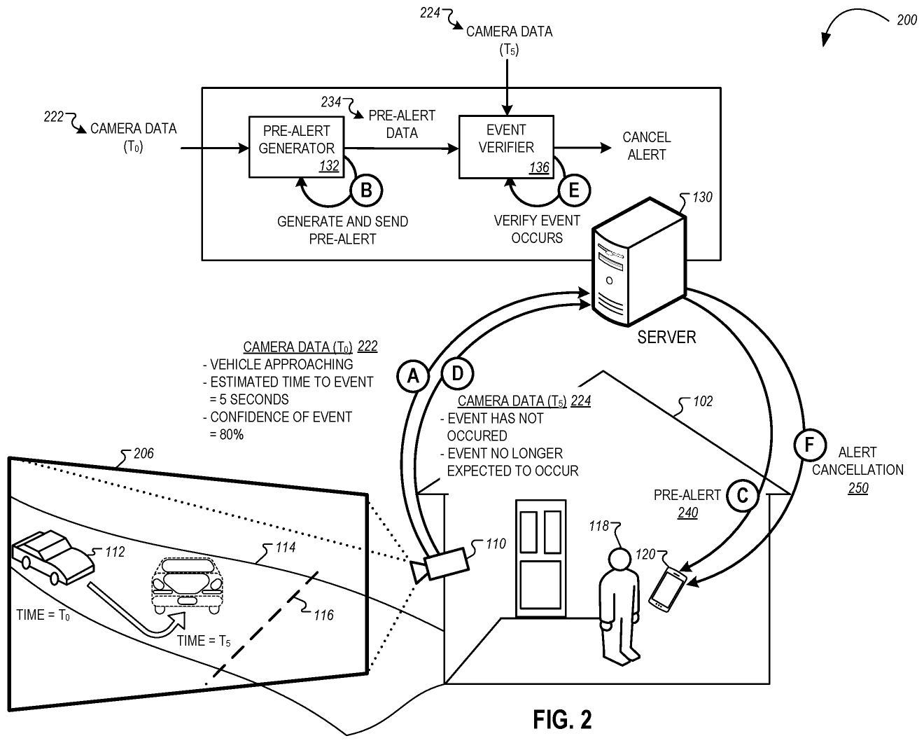

The pre-alert 140 can be encoded to display an alert 150 on the mobile device 120 at the expected time of event. For example, the pre-alert 140 can be programmed to be cached on the mobile device 120 until time T₅. If the monitoring server 130 does not send a command to cancel or delay the alert 150 before time T₅, the mobile device 120 displays the alert 150 at time T₅. Cancellation of the alert is described in greater detail with reference to FIG. 2.

After sending the pre-alert 140, the monitoring server 130 can continue to receive camera data between time T₀ and time T₅. The monitoring server 130 can analyze the camera data in order to update the pre-alert. For example, the monitoring server 130 may analyze the camera data and determine that the vehicle 112 is slowing down. Based on the vehicle 112 slowing down, the monitoring server 130 may determine that the expected time of event is T₆ instead of T₅. In another example, the monitoring server 130 may analyze the camera data and determine that the vehicle 112 is accelerating. Based on the vehicle 112 accelerating, the monitoring server 130 may determine that the expected time of event is T₃ instead of T₅.

In response to determining that the expected time of event is different from the initial expected time of event determined at time T₀, e.g., earlier or later than T₅, the monitoring server 130 may send the updated expected time of event to the mobile device 120. The mobile device 120 can then provide the alert to the resident at the new expected time of event.

In some examples, after sending the pre-alert 140, the monitoring server 130 may continue to send data and video captured between time T₀ and time T₅ to be cached on the mobile device 120. Thus, when the alert 150 is provided to the resident 118, the video captured between time T₀ and time T₅ is pre-loaded and available for viewing by the resident 118.

In stage (D) of FIG. 1, the monitoring server 130 receives camera data 124 captured at time T₅. The camera 110 can send the camera data 124 from time T₅ to the monitoring server 130 over the long-range data link.

The camera data 124 includes images of the vehicle 112 crossing the virtual line crossing 116 on the driveway 114. In some examples, the camera 110 can send clips of the video 106 or select image frames to send to the monitoring server 130. In some examples, the camera 110 can continue to send the live stream of the video 106 to the monitoring server 130, e.g., the live stream of the video 106 that started at or before time T₀ and ends at or after the time T₅.

In some examples, the camera 110 can perform video analysis on the video 106, and can send results of the video analysis to the monitoring server 130. For example, the camera 110 can determine through video analysis that the vehicle 112 crosses the virtual line crossing 116 at time T₅. The camera data 124 can then send a message to the monitoring server 130 indicating that the vehicle 112 has crossed the virtual line crossing 116. The camera 110 may send the message to the monitoring server 130 in addition to, or instead of, the image frames of the video 106. The camera data 124 can include a time of event that the vehicle 112 crossed the virtual line crossing 116. In FIG. 1, the time of the event is T₅, or five seconds after T₀.

In stage (E) of FIG. 1, the monitoring server 130 verifies the event. The monitoring server 130 can include an event verifier 136 that analyzes the camera data 124. If the event is verified, the event verifier 136 can determine to allow the alert. If the event is not verified, the event verifier 136 can determine to cancel the alert or delay the alert.

The event verifier 136 can receive the camera data 124 and pre-alert data 134. The pre-alert data can include some or all of the data included in the pre-alert 140 sent to the mobile device 120. For example, the pre-alert data can include the predicted event, the estimated time of event, and the confidence value of the event as determined at time T₀. The pre-alert data 134 can also include camera images and camera video analysis results.

The event verifier 136 can compare the pre-alert data 134 to the camera data 124 to determine if the camera data 124 aligns with the pre-alert data 134. For example, the event verifier 136 can determine if the predicted event occurred. The event verifier 136 can also determine if the event occurred at the estimated time of event, or within a threshold deviation from the estimated time of event. For example, the threshold deviation may be one second. Thus, the event verifier 136 can determine if the event occurred within one second before or after time T₅.

If the event verifier 136 determines that the event occurred at the time of event, or within the threshold deviation from the estimated time of event, the event verifier can allow the alert 150. In some examples, the event verifier 136 can allow the alert 150 by taking no action. If the event verifier 136 takes no action, the alert 150 automatically displays on the mobile device 120 at time T₅.

In some examples, the event verifier 136 may determine that the event occurred outside of the threshold deviation from the estimated time of event. For example, the event verifier 136 may determine that the event occurred two seconds earlier than the expected time of event, e.g., at time T₃. In response to determining that the event occurred at time T₃, the event verifier 136 may send a command to the mobile device 120 to display the alert 150 including notification text stating that the event occurred at time T₃ instead of time T₅.

In some examples, the event verifier 136 may determine that the event is expected to occur, but will likely occur later than the estimated time of event, and outside of the threshold deviation from the estimated time of event. The event verifier 136 may then send a command to the mobile device 120 to wait until the new estimated time of event before displaying the alert 150. At the new estimated time of event, the event verifier 136 can re-evaluate the camera data and again determine to allow or cancel the alert 150.

In some examples, the event verifier 136 may determine that the event is expected to occur, but will likely occur at a later, unknown time. For example, the vehicle 112 may stop before crossing the virtual line crossing 116. The event verifier 136 may then send a command to the mobile device 120 to wait until receiving an additional command before displaying the alert 150. When the vehicle 112 starts moving again, the event verifier 136 can send the command to the mobile device, including an updated estimated time of event.

In some examples, the event verifier 136 may determine that the event is no longer expected to occur. The event verifier 136 may then send a command to the mobile device 120 to cancel the alert 150.

In stage (F) of FIG. 1, the mobile device 120 displays the alert 150. The alert 150 can include information related to the type of event detected and the time of detection. The alert 150 can include the notification text sent with the pre-alert 140, e.g., “Vehicle Entered Driveway at Time T₅.”

When the resident 118 views the alert 150, the mobile device 120 may provide the resident 118 with an option to view an image or video of the event. For example, the mobile device 120 may display a thumbnail image 152 of the vehicle 112. The resident 118 may select the thumbnail image 152 through a user interface, and the mobile device 120 can then display the video showing the vehicle 112 crossing the virtual line crossing 116. In some examples, the video can show marked-up images, e.g., images that show a mark-up of the virtual line crossing 116. The marked-up images can also include, for example, timestamps showing a time of the images.

In some examples, the mobile device 120 can display the video that was pre-cached prior to the alert 150 being shown. Since the video was pre-cached, the resident 118 can view the video with little or no delay. In some examples, after displaying pre-cached video, the mobile device 120 may display a live video stream, e.g., video captured by the camera 110 after time T₅.

In some examples, the resident 118 might not view the alert 150 immediately at time T₅. The mobile device 120 can store the alert 150, including any video or images, for later display to the resident 118. The monitoring server 130 can continue to send data and video to the mobile device 120 after time T₅ and before the resident 118 views the alert 150. Thus, when the resident 118 views the alert 150 after time T₅, the resident 118 may be able to view additional information and video that was not available at time T₅. The additional information can include video analysis results, e.g., a make and model of the vehicle 112. The additional video may include images captured from before time T₀ to after T₅.

The monitoring server 130 can continue to send data and video to the mobile device 120 while the resident 118 views the alert 150 and after the resident 118 views the alert 150. In some examples, the monitoring server 130 may send a second alert to the mobile device 120 after the resident 118 views the alert 150. For example, the monitoring server 130 may send the second alert to the mobile device 120 to inform the resident 118 that additional information and/or video is available for viewing.

In some examples, the mobile device 120 can introduce a delay between the expected time of event and a time of displaying the alert 150. The delay can allow for a last minute cancellation or confirmation message related to the event. For example, if the vehicle 112 stops abruptly, immediately before crossing the virtual line crossing 116 at time T₅, the monitoring server 130 can send a cancellation to the mobile device 120. If the mobile device 120 receives the cancellation during the delay, the mobile device 120 can stop the alert 150 from displaying.

In another example, when the vehicle 112 crosses the virtual line crossing 116 at time T₅, the monitoring server 130 can send a confirmation message to the mobile device 120 during the delay, indicating that the event occurred. In response to receiving the confirmation message, the mobile device 120 can display the alert 150. Since the event data is already pre-cached on the mobile device 120, the mobile device 120 can display the alert 150 with little or no delay.

In some examples, the monitoring server 130 can encrypt video that is sent with the pre-alert 140. For example, when sending the pre-alert 140 to a third party device, the monitoring server 130 may encrypt the video in order to prevent access to the video unless and until the event is confirmed. When the event occurs, e.g., when the vehicle 112 crosses the virtual line crossing 116, the monitoring server 130 can send a confirmation message to the third party device that includes a decryption key for the encrypted video. The third party device can then decrypt the video. If the predicted event does not occur, the monitoring server 130 does not send the decryption key. The third party device can then delete the pre-alert 140, e.g., after a delay of a programmed length of time, and the monitoring server 130 can delete the decryption key.

In some implementations, the system 100 includes a control unit. The control unit can receive sensor data from the various sensors at the property 102, including the camera 110. The control unit can send the sensor data to the monitoring server 130. In some examples, the sensors communicate electronically with the control unit through a network.

The network may be any communication infrastructure that supports the electronic exchange of data between the control unit and the sensors. The network may include a local area network (LAN), a wide area network (WAN), the Internet, or other network topology. The network may be any one or combination of wireless or wired networks and may include any one or more of Ethernet, cellular telephony, Bluetooth, Wi-Fi, Z-Wave, ZigBee, Bluetooth, and Bluetooth LE technologies. In some implementations, the network may include optical data links. To support communications through the network, one or more devices of the system 100 may include communications modules, such as a modem, transceiver, modulator, or other hardware or software configured to enable the device to communicate electronic data through the network.

The control unit may be a computer system or other electronic device configured to communicate with components of the system 100 to cause various functions to be performed for the system 100. The control unit may include a processor, a chipset, a memory system, or other computing hardware. In some cases, the control unit may include application-specific hardware, such as a field-programmable gate array (FPGA), an application-specific integrated circuit (ASIC), or other embedded or dedicated hardware. The control unit may include software, which configures the unit to perform the functions described in this disclosure. In some implementations, a resident 118 of the property 102, or another user, communicates with the control unit through a physical connection (e.g., touch screen, keypad, etc.) and/or network connection. In some implementations, the resident 118 or other user communicates with the control unit through a software (“smart home”) application installed on the mobile device 120.

The system 100 for pre-generating video event notifications may undergo a site-specific training phase upon installation at the property 102. During the training phase, components of the system, e.g., the camera 110 and the monitoring server 130 may use a machine learning algorithm to learn to recognize familiar objects. For example, the system 100 can learn to identify the residents and pets of the property 102. The system 100 can also learn to identify the vehicles of the residents of the property. The system 100 can learn to recognize routine events, e.g., a certain vehicle departing the property at a certain time each morning.

The system 100 can continue to train on an ongoing basis while in operation, instead of or in addition to the training phase. The system 100 can collect video images from past events that occurred, as well as samples of detected activity that did not result in any alert. From this data, the system 100 can extract patterns of activity that typically lead to an alert. This data collection and analysis can continue while the camera 110 is in operation at the property 102. The system 100 can continuously refine its prediction models over time.

In some examples, the system 100 can update prediction models each time an alert is generated based on camera data from the camera 110. For example, an event may occur in which the vehicle 112 enters the driveway 114 and crosses the virtual line crossing 116. When the vehicle 112 crosses the virtual line crossing 116, the monitoring server 130 sends an alert to the mobile device 120. The monitoring server 130 can then obtain and analyze camera data from images captured by the camera 110 prior to the vehicle 112 crossing the virtual line crossing 116. Based on analyzing the camera data, the monitoring server 130 may determine an initial position, a direction, and a speed of the vehicle 112 before the vehicle 112 crossed the virtual line crossing 116. Thus, based on analyzing past events that caused alerts, the monitoring server 130 can learn to better predict future alerts.

In some examples, the resident 118 or another user can provide feedback to the system 100 to improve prediction of events. For example, an event may occur, and the resident 118 may receive an alert after a delay. In another example, the resident 118 may receive an alert for a predicted event that did not occur. When false alerts and delayed alerts occur, the resident 118 can provide feedback to the system 100, e.g., through an interface on the mobile device 120. Based on the feedback, the system 100 can adjust one or more criteria for generating alerts and pre-alerts. Over time, based on user feedback, the system can reduce latency of alerts, and can improve accuracy by reducing false alerts.

Though described above as being performed by a particular component of system 100 (e.g., the control unit, the camera 110 or the monitoring server 130), any of the various control, processing, and analysis operations can be performed by either the control unit, the camera 110, the monitoring server 130, or another computer system of the system 100. For example, the control unit, the monitoring server 130, the camera 110, or another computer system can analyze the data from the sensors to determine system actions. Similarly, the control unit, the monitoring server 130, the camera 110, or another computer system can control the various sensors, and/or property automation controls to collect data or control device operation.

In some implementations, the system 100 includes the control unit and does not include the monitoring server 130, and the control unit can perform the actions described above as being performed by the monitoring server 130. In some implementations, the system 100 does not include the control unit nor the monitoring server 130, and the camera 110 can perform the actions described above as being performed by the monitoring server 130.

FIG. 2 illustrates an example system 200 for pre-generating video event notifications for a predicted event that does not occur. The system 200 includes the camera 110 installed at the property 102, the remote server 130, and the mobile device 120 associated with the resident 118. The camera 110 captures video 206. The video 206 includes image frames of the vehicle 112 driving on the driveway 114, approaching the property 102.

The video 206 includes multiple image frames captured over time. For example, the image frames captured at time T₀, images frames captured at time T₅, and images frames captured between time T₀ and time T₅, where time T₅ is five seconds after time T₀. The image frames of the video 206 show an outdoor scene of the vehicle 112 driving on the driveway 114.

The camera 110 may perform video analysis on the video 206. Video analysis can include detecting, identifying, and tracking objects in the video 206. Objects can include, for example, people, vehicles, and animals. Video analysis can also include determining if an event occurs. An event can include, for example, an object crossing a virtual line crossing, e.g., virtual line crossing 116.

FIG. 2 illustrates a flow of data, shown as stages (A) to (F), which can represent steps in an example process. Stages (A) to (F) may occur in the illustrated sequence, or in a sequence that is different from the illustrated sequence. For example, some of the stages may occur concurrently.

In stage (A) of FIG. 2, the monitoring server 130 receives camera data 222 captured at time T₀. The camera 110 can send the camera data 222 to the monitoring server 130 over the long-range data link. The camera data 222 includes images of the vehicle 112 approaching the virtual line crossing 116 on the driveway 114. In some examples, the camera 110 can send clips of the video 206 to the monitoring server 130. In some examples, the camera 110 can select image frames to send to the monitoring server 130. For example, the camera 110 can select image frames that include an object of interest, e.g., the vehicle 112, to send to the monitoring server 130. In some examples, the camera 110 can send a live stream of the video 206 to the monitoring server 130, e.g., a live stream of the video 206 that starts at or before time T₀ and ends at or after the time T₅.

In some examples, the camera 110 can perform video analysis on the video 206, and can send results of the video analysis to the monitoring server 130. For example, the camera 110 can determine through video analysis that the vehicle 112 is approaching the virtual line crossing 116. The camera data 222 can then send a message to the monitoring server 130 indicating that the vehicle 112 is approaching the virtual line crossing 116. The camera 110 may send the message to the monitoring server 130 in addition to, or instead of, the image frames of the video 206.

The camera data 222 can include an estimated time of a predicted event, e.g., an estimated time that the vehicle 112 will cross the virtual line crossing 116. The estimated time of the event can be based on a position of the vehicle 112 at time T₀, an estimated speed of the vehicle 112, a direction of the vehicle 112, and a position of the virtual line crossing 116. In FIG. 2, the estimated time of the event is T₅, or five seconds after T₀.

The camera data 222 can include a confidence value of the event occurring. For example, the camera data 222 can include a confidence value that the vehicle 112 will cross the virtual line crossing, a confidence that the vehicle 112 will cross the virtual line at time T₅, or both. In FIG. 2, the camera data 222 includes a confidence value of 80% that the vehicle 112 will cross the virtual line crossing 116.

The camera 110 may continue to send camera data after sending the camera data 222. For example, the camera 110 may send the camera data 222 based on images captured at time T₀, and then may send camera data based on images captured at time T₁, T₂, etc. As the camera 110 continues to send camera data to the monitoring server 130 over time, the camera 110 can send an updated time to event and an updated confidence of event. For example, as the vehicle 112 approaches the virtual line crossing 116, the camera 110 can reduce the estimated time to the event, and raise the confidence of the event.

In stage (B) of FIG. 2, the monitoring server 130 generates a pre-alert 240. The monitoring server 130 can include a pre-alert generator 132 that analyzes the camera data 222 and generates the pre-alert 240 based on the camera data 222. The pre-alert 240 can include one or more predictions of near future activity based on the camera data 222.

In stage (C) of FIG. 2, the monitoring server 130 sends the pre-alert 240 to the mobile device 120. When the mobile device 120 receives the pre-alert 240, the mobile device 120 does not immediately display the pre-alert. Rather, the mobile device 120 can cache the pre-alert for later display to the resident 118, e.g., for display to the resident 118 at the estimated time of the event.

The pre-alert 240 can be encoded to display an alert on the mobile device 120 at the expected time of event. For example, the pre-alert 240 can be programmed to be cached on the mobile device 120 until time T₅. If the monitoring server 130 does not send a command to cancel the alert before time T₅, the mobile device 120 displays the alert.

In stage (D) of FIG. 2, the monitoring server 130 receives camera data 224 captured at time T₅. The camera 110 can send the camera data 224 from time T₅ to the monitoring server 130 over the long-range data link.

The camera data 224 includes images of the vehicle 112 in the driveway 114. The vehicle 112 has not crossed the virtual line crossing 116 on the driveway 114. The vehicle 112 has also changed directions, so that the vehicle 112 is no longer moving towards the virtual line crossing 116.

In some examples, the camera 110 can perform video analysis on the video 206, and can send results of the video analysis to the monitoring server 130. For example, the camera 110 can determine through video analysis that the vehicle 112 has not crossed the virtual line crossing 116 at time T₅. The camera data 224 can then send a message to the monitoring server 130 indicating that the vehicle 112 has not crossed the virtual line crossing 116. The camera 110 may send the message to the monitoring server 130 in addition to, or instead of, the image frames of the video 206. The camera data 224 can include an updated expected time of event for the vehicle 112 crossing the virtual line crossing 116. In FIG. 2, since the vehicle 112 has changed directions, the camera data 224 includes that the vehicle 112 is no longer expected to cross the virtual line crossing 116.

In stage (E) of FIG. 2, the monitoring server 130 verifies the event. The monitoring server 130 can include an event verifier 136 that analyzes the camera data 224 and determines to allow the alert or to cancel the alert.

The event verifier can receive the camera data 224 and pre-alert data 234. The pre-alert data can include some or all of the data included in the pre-alert 240 sent to the mobile device 120. For example, the pre-alert data can include a predicted event, an estimated time of event, and a confidence value of the event. The pre-alert data 234 can also include camera images and camera video analysis result.

The event verifier 136 can compare the pre-alert data 234 to the camera data 224 to determine if the camera data 224 aligns with the pre-alert data 234. For example, the event verifier 136 can determine if the predicted event occurred.

If the event verifier 136 determines that the event occurred, the event verifier 136 can allow the alert. In some examples, the event verifier 136 can allow the alert by taking no action. If the event verifier 136 takes no action, the alert displays on the mobile device 120 at time T₅.

If the event verifier 136 determines that the event is no longer expected to occur, the event verifier 136 can determine to cancel the alert. The event verifier 136 may then send an alert cancellation 250 to the mobile device 120 to cancel the alert.

In the example of FIG. 2, the event verifier 136 determines that the vehicle 112 has not crossed the virtual line crossing 116. Additionally, based on analysis of the camera data 224, the event verifier 136 determines that the vehicle 112 is not likely to cross the virtual line crossing 116. Thus, the event verifier 136 determines to cancel the alert.

In stage (F) of FIG. 2, the monitoring server 130 sends the alert cancellation 250 to the mobile device 120. The alert cancellation 250 can include a command to the mobile device 120 to not provide the alert to the resident. The alert cancellation 250 may also include a command to the mobile device 120 to delete the pre-alert 240 pre-cached on the mobile device 120. In response to receiving the alert cancellation 250, the mobile device 120 does not display the alert.

In some examples, the monitoring server 130 may send the alert cancellation 250 after the mobile device 120 has already displayed the alert. In response to receiving the alert cancellation 250 after the mobile device 120 has already displayed the alert, the mobile device 120 can retract the alert. For example, if the resident 118 has not yet viewed the alert, the mobile device 120 can delete the alert and the pre-cached data. If the resident 118 has already reviewed the alert, the mobile device 120 can provide a correction message stating that the event did not occur.

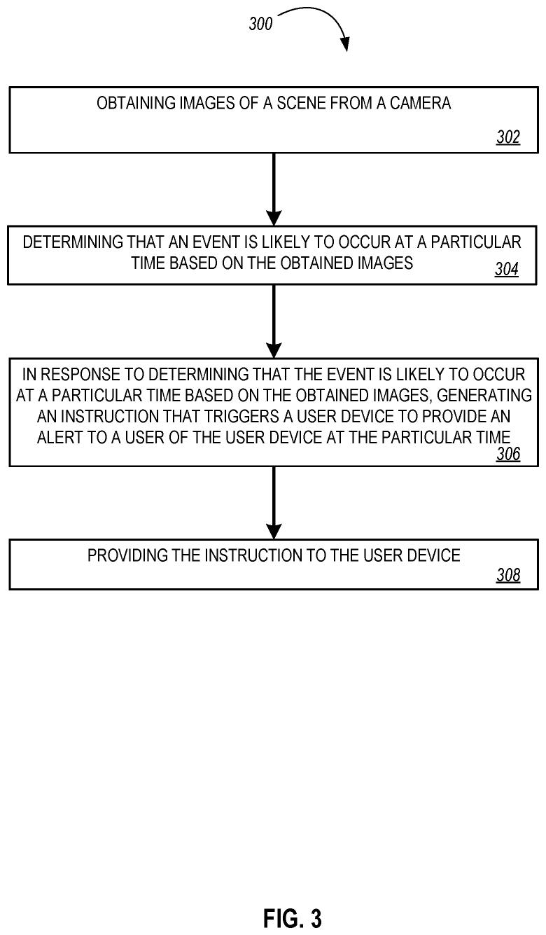

FIG. 3 is a flow chart illustrating an example of a process 300 for pre-generating video event notifications. The process 300 can be performed by a computing system such as a camera, e.g. the camera 110. In some implementations, the process 300 can be performed by one or more computer systems that communicate electronically with a camera, e.g., over a network. For example, the process can be performed by a monitoring server, e.g., the monitoring server 130, or a control unit. In some implementations, some steps of the process 300 can be performed by one computing system, e.g., the camera 110, and other steps of the process 300 can be performed by another computing system, e.g., the monitoring server 130.

Briefly, process 300 includes obtaining images of a scene from a camera (302), determining that an event is likely to occur at a particular time based on the obtained images (304), in response to determining that the event is likely to occur at a particular time based on the obtained images, generating an instruction that triggers a user device to provide an alert to a user of the user device at the particular time (306), and providing the instruction to the user device (308).

In additional detail, the process 300 includes obtaining images of a scene from a camera (302). For example, the camera 110 can be positioned to view a scene that includes a porch of the property 102. The monitoring server 130 can obtain images of the scene from the camera 110. The images can include objects, e.g., people, vehicles, or animals. The images of the scene can include still images or video images.

In some implementations, the images of the scene are obtained at a first time. For example, the images of the scene can be captured over a time frame that ends at a first time. The images can be captured over various time frames. For example, the images can be captured over a time frame of less than a second, a few seconds, a minute, etc. In an example scenario, the images of the scene obtained over a time frame of ten seconds can show a person approaching a virtual line crossing positioned on the porch of the property. The images may be obtained at a first time of 10:05:10 pm.

The process 300 includes determining that an event is likely to occur at a particular time based on the obtained images (304). In some implementations, the event includes at least one of an object crossing a virtual line crossing, an object entering an area of interest, an object being present in an area of interest for greater than a threshold period of time, or an object entering an area of interest. For example, an event can include an vehicle crossing a virtual line crossing, a human loitering near the camera 110, or human or animal passing by the camera 110 multiple times. The particular time can include a time within a number of seconds from the time when the images were obtained, e.g., ten seconds, twenty seconds, or thirty seconds. In the example scenario, the monitoring server 130 may determine that the person is likely to cross the virtual line crossing five seconds after the first time when the images were obtained, e.g., at 10:05:15 pm.

In some implementations, determining that the event is likely to occur at the particular time includes determining that a confidence that the event will occur at the particular time exceeds a threshold confidence. For example, the system may determine a confidence level of 80%. The threshold confidence level may be 70%. Thus, based on the confidence level of 80% exceeding the threshold confidence level of 70%, the system can determine that the person is likely going to cross the virtual line crossing at 10:05:15 pm.

In some implementations, determining that an event is likely to occur at a particular time based on the obtained images includes determining a position, speed, and direction of an object in the obtained images and determining a position of an area of interest in the obtained images. Based on the position, speed, and direction of the object and based on the position of the area of interest, the system can determine that the object is likely to enter the area of interest at the particular time. In the example, scenario, the area of interest may be an area that is past the virtual line crossing. The system can determine a position, speed, and direction of the person in the obtained images, and the position of the area of interest in the obtained images. Based on the position, speed, and direction of the person, the system can determine the estimated time that the person is likely to cross the virtual line crossing and enter the area of interest.

The process 300 includes, in response to determining that the event is likely to occur at a particular time based on the obtained images, generating an instruction that triggers a user device to provide an alert to a user of the user device at the particular time (306). For example, the monitoring server 130 can generate an instruction that triggers the mobile device 120 to provide the alert 150 to the resident 118 at the particular time.

In some implementation, the instruction that triggers the user device to provide the alert at the particular time includes alert data. The alert data can include at least one of: the obtained images of the scene; notification text to be displayed by the user device; a classification of an object identified in the images; the particular time that the event is likely to occur; or a classification of the event. The obtained images of the scene can include, for example, images of the person approaching the porch. The alert data can include data indicating that the detected object is classified as a person, a label indicating that the person is unfamiliar, and notification text stating “An unfamiliar person is on the porch.” The alert data can also include an estimated time of 1:05:15 pm when the person is expected to cross the virtual line crossing.

The process 300 includes providing the instruction to the user device (308). For example, the monitoring server 130 can provide the instruction to the mobile device 120. In some implementations, providing the instruction to the user device includes providing, to the user device, the alert data and an instruction to pre-cache the alert data until the particular time. For example, the monitoring server 130 can provide the alert data to the mobile device 120 with an instruction to pre-cache the alert data until 10:05:15 pm.

In some implementations, the process 300 includes providing, to the user device, a live video stream of the scene. For example, after sending the instruction to the mobile device 120, the monitoring server 130 or the camera 110 cam send a live stream of video captured by the camera 110 to the mobile device 120. The live stream may continue, for example, until the event occurs, until a programmed time duration has passed after the event occurs, or until the user ends the live stream.

In some implementations, the process 300 includes providing, to the user device, video of the scene captured by the camera during a first programmed time duration before the particular time and during a second programmed time duration after the particular time. For example, the video of the scene can include video that was captured by the camera 110 and stored by the monitoring server 130 during the first programmed time duration and the second programmed time duration.

In some implementations, the first programmed time duration includes a particular number of seconds prior to the first time, and a time duration between the first time and the particular time. For example, the first programmed time duration may include fifteen seconds prior to the first time, and the time between the first time and the particular time of the expected event. In the example scenario, fifteen seconds prior to the first time is between 10:04:55 pm and 10:05:10 pm. The time between the first time and the particular time is between 10:05:10 pm and 10:05:15 pm. Therefore a first programmed time duration may be from 10:04:55 pm to 10:05:15 pm. The video of the scene captured by the camera during the first programmed time duration may show the person entering the scene, approaching the virtual line crossing, and crossing the virtual line crossing.

In some implementations, the second programmed time duration includes a particular number of seconds after the particular time. For example, the programmed time duration may include ten seconds after the particular time of the expected event. In the example scenario, ten seconds after the particular time is between 10:05:15 pm and 10:05:25 pm. The video of the scene captured by the camera during the second programmed time duration may show the person's movements after crossing the virtual line crossing.

Following providing the instruction to the user device, the monitoring server 130 can obtain additional images in order to verify the predicted event. The additional images can include images captured by the camera 110 after providing the instruction to the user device. In the example scenario, the additional images can include images captured by the camera 110 after 10:05:10 pm.

In some implementations, the process 300 includes obtaining additional images of the scene from the camera and determining, based on the additional images, that the event occurred within a programmed time deviation from the particular time. For example, the programmed time deviation may be 1.0 seconds, 1.5 seconds, or 2.0 seconds. Based on determining that the event occurred within a programmed time deviation from the particular time, the system can allow the user device to provide the alert by providing no additional instruction to the user device. In the example scenario, the programmed time deviation may be 2.0 seconds. The system may determine, based on the additional images, that the person crossed the virtual line crossing at 10:05:16 pm, which is 1.0 seconds later than the particular time of the expected event. Based on the event occurring within the time deviation of 2.0 seconds from the particular time, the system can allow the mobile device 120 to provide the alert. In some implementations, allowing the user device to provide the alert includes not providing an instruction to the user device to cancel providing the alert at the particular time.

In some implementations, the process 300 includes obtaining additional images of the scene from the camera and determining, based on the additional images, that the event is likely to occur at a second time, the second time being earlier than the particular time by greater than a programmed time deviation. Based on determining that the event is likely to occur at the second time, the system can generate an updated instruction that triggers the user device to provide the alert at the second time, and instructs the user device not to provide the alert at the particular time. In the example scenario, the programmed time deviation may be 2.0 seconds. The system may determine, based on obtaining the additional images, that the person is likely to cross the virtual line crossing at a second time of 10:05:12 pm, which is 3.0 seconds earlier than the particular time of the expected event. Based on the event being expected to occur 3.0 seconds early, which is a greater deviation than 2.0 seconds, the monitoring server 130 can generate and provide the updated instruction to the mobile device 120 to provide the alert at 10:05:12 pm instead of at 10:05:15 pm.

In some implementations, the process 300 includes obtaining additional images of the scene from the camera and determining, based on the additional images, that the event is likely to occur at a third time, the third time being later than the particular time by greater than a programmed time deviation. Based on determining that the event is likely to occur at the third time, the system can generate an updated instruction that triggers the user device to provide the alert at the third time, and instructs the user device not to provide the alert at the particular time. In the example scenario, the system may determine, based on the additional images, that the person is likely to cross the virtual line crossing at a third time of 10:05:21 pm, which is 6.0 seconds after the particular time of the expected event. Based on the event being expected to occur 6.0 seconds late, which is a greater deviation than the programmed deviation of 2.0 seconds, the monitoring server 130 can generate and provide the updated instruction to the mobile device 120 to provide the alert at a third time of 10:05:21 pm instead of at 10:05:15 pm.

In some implementations, the process 300 includes, after providing the updated instruction to the user device, obtaining second additional images from the camera and verifying, based on the second additional images, that the event is likely to occur within a programmed time deviation from the third time. For example, the second additional images can be images obtained by the camera 110 after the monitoring server 130 sends the updated instruction to the mobile device 120. After providing the updated instruction to the mobile device 120 to provide the alert at the third time of 10:05:21 pm, the monitoring server 130 may confirm that the event is likely to occur at 10:05:21 pm based on analyzing the second additional images. Based on verifying that the event is likely to occur at the third time, the system can allow the user device to provide the alert at the third time by providing no additional instruction to the user device.

In some implementations, the process 300 includes obtaining additional images of the scene from the camera and determining, based on the additional images, that the event is not likely to occur. For example, the monitoring server 130 may determine that the predicted event did not occur, and is not expected to occur. In the example scenario the person approaching the porch may turn around and walk away from the porch before crossing the virtual line crossing, and before the particular time of 10:05:15 pm. Based on determining that the event is not likely to occur, the system can generate an updated instruction that instructs the user device to cancel providing the alert at the particular time. The system can then provide the updated instruction to the user device. For example, the monitoring server 130 can send a cancellation instruction to the mobile device 120, and the mobile device 120 will not provide the alert to the user.

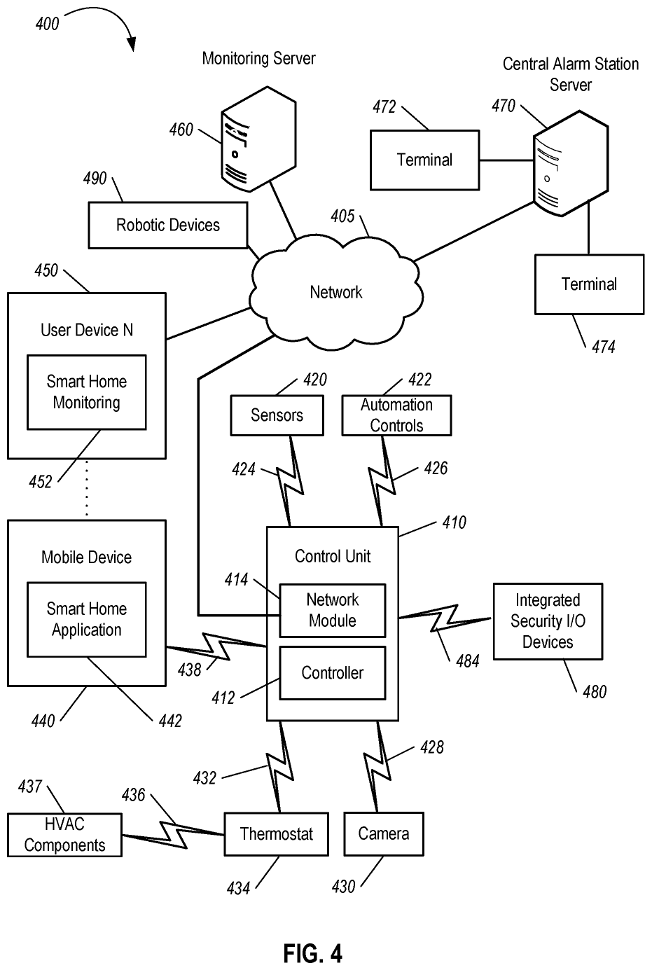

FIG. 4 is a diagram illustrating an example of a home monitoring system 400. The monitoring system 400 includes a network 405, a control unit 410, one or more user devices 440 and 450, a monitoring server 460, and a central alarm station server 470. In some examples, the network 405 facilitates communications between the control unit 410, the one or more user devices 440 and 450, the monitoring server 460, and the central alarm station server 470.

The network 405 is configured to enable exchange of electronic communications between devices connected to the network 405. For example, the network 405 may be configured to enable exchange of electronic communications between the control unit 410, the one or more user devices 440 and 450, the monitoring server 460, and the central alarm station server 470. The network 405 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 405 may include multiple networks or subnetworks, each of which may include, for example, a wired or wireless data pathway. The network 405 may include a circuit-switched network, a packet-switched data network, or any other network able to carry electronic communications (e.g., data or voice communications). For example, the network 405 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 405 may include one or more networks that include wireless data channels and wireless voice channels. The network 405 may be a wireless network, a broadband network, or a combination of networks including a wireless network and a broadband network.

The control unit 410 includes a controller 412 and a network module 414. The controller 412 is configured to control a control unit monitoring system (e.g., a control unit system) that includes the control unit 410. In some examples, the controller 412 may include a processor or other control circuitry configured to execute instructions of a program that controls operation of a control unit system. In these examples, the controller 412 may be configured to receive input from sensors, flow meters, or other devices included in the control unit system and control operations of devices included in the household (e.g., speakers, lights, doors, etc.). For example, the controller 412 may be configured to control operation of the network module 414 included in the control unit 410.

The network module 414 is a communication device configured to exchange communications over the network 405. The network module 414 may be a wireless communication module configured to exchange wireless communications over the network 405. For example, the network module 414 may be a wireless communication device configured to exchange communications over a wireless data channel and a wireless voice channel. In this example, the network module 414 may transmit alarm data over a wireless data channel and establish a two-way voice communication session over a wireless voice channel. The wireless communication device may include one or more of a LTE module, a GSM module, a radio modem, cellular transmission module, or any type of module configured to exchange communications in one of the following formats: LTE, GSM or GPRS, CDMA, EDGE or EGPRS, EV-DO or EVDO, UMTS, or IP.

The network module 414 also may be a wired communication module configured to exchange communications over the network 405 using a wired connection. For instance, the network module 414 may be a modem, a network interface card, or another type of network interface device. The network module 414 may be an Ethernet network card configured to enable the control unit 410 to communicate over a local area network and/or the Internet. The network module 414 also may be a voice band modem configured to enable the alarm panel to communicate over the telephone lines of Plain Old Telephone Systems (POTS).

The control unit system that includes the control unit 410 includes one or more sensors. For example, the monitoring system may include multiple sensors 420. The sensors 420 may include a lock sensor, a contact sensor, a motion sensor, or any other type of sensor included in a control unit system. The sensors 420 also may include an environmental sensor, such as a temperature sensor, a water sensor, a rain sensor, a wind sensor, a light sensor, a smoke detector, a carbon monoxide detector, an air quality sensor, etc. The sensors 420 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health-monitoring sensor can be a wearable sensor that attaches to a user in the home. The health-monitoring sensor can collect various health data, including pulse, heart rate, respiration rate, sugar or glucose level, bodily temperature, or motion data.

The sensors 420 can also include a radio-frequency identification (RFID) sensor that identifies a particular article that includes a pre-assigned RFID tag.

The control unit 410 communicates with the home automation controls 422 and a camera 430 to perform monitoring. The home automation controls 422 are connected to one or more devices that enable automation of actions in the home. For instance, the home automation controls 422 may be connected to one or more lighting systems and may be configured to control operation of the one or more lighting systems. In addition, the home automation controls 422 may be connected to one or more electronic locks at the home and may be configured to control operation of the one or more electronic locks (e.g., control Z-Wave locks using wireless communications in the Z-Wave protocol). Further, the home automation controls 422 may be connected to one or more appliances at the home and may be configured to control operation of the one or more appliances. The home automation controls 422 may include multiple modules that are each specific to the type of device being controlled in an automated manner. The home automation controls 422 may control the one or more devices based on commands received from the control unit 410. For instance, the home automation controls 422 may cause a lighting system to illuminate an area to provide a better image of the area when captured by a camera 430.

The camera 430 may be a video/photographic camera or other type of optical sensing device configured to capture images. For instance, the camera 430 may be configured to capture images of an area within a building or home monitored by the control unit 410. The camera 430 may be configured to capture single, static images of the area and also video images of the area in which multiple images of the area are captured at a relatively high frequency (e.g., thirty images per second). The camera 430 may be controlled based on commands received from the control unit 410.

The camera 430 may be triggered by several different types of techniques. For instance, a Passive Infra-Red (PIR) motion sensor may be built into the camera 430 and used to trigger the camera 430 to capture one or more images when motion is detected. The camera 430 also may include a microwave motion sensor built into the camera and used to trigger the camera 430 to capture one or more images when motion is detected. The camera 430 may have a “normally open” or “normally closed” digital input that can trigger capture of one or more images when external sensors (e.g., the sensors 420, PIR, door/window, etc.) detect motion or other events. In some implementations, the camera 430 receives a command to capture an image when external devices detect motion or another potential alarm event. The camera 430 may receive the command from the controller 412 or directly from one of the sensors 420.

In some examples, the camera 430 triggers integrated or external illuminators (e.g., Infra-Red, Z-wave controlled “white” lights, lights controlled by the home automation controls 422, etc.) to improve image quality when the scene is dark. An integrated or separate light sensor may be used to determine if illumination is desired and may result in increased image quality.

The camera 430 may be programmed with any combination of time/day schedules, system “arming state,” or other variables to determine whether images should be captured or not when triggers occur. The camera 430 may enter a low-power mode when not capturing images. In this case, the camera 430 may wake periodically to check for inbound messages from the controller 412. The camera 430 may be powered by internal, replaceable batteries if located remotely from the control unit 410. The camera 430 may employ a small solar cell to recharge the battery when light is available. Alternatively, the camera 430 may be powered by the controller's 412 power supply if the camera 430 is co-located with the controller 412.

In some implementations, the camera 430 communicates directly with the monitoring server 460 over the Internet. In these implementations, image data captured by the camera 430 does not pass through the control unit 410 and the camera 430 receives commands related to operation from the monitoring server 460.

The system 400 also includes thermostat 434 to perform dynamic environmental control at the home. The thermostat 434 is configured to monitor temperature and/or energy consumption of an HVAC system associated with the thermostat 434, and is further configured to provide control of environmental (e.g., temperature) settings. In some implementations, the thermostat 434 can additionally or alternatively receive data relating to activity at a home and/or environmental data at a home, e.g., at various locations indoors and outdoors at the home. The thermostat 434 can directly measure energy consumption of the HVAC system associated with the thermostat, or can estimate energy consumption of the HVAC system associated with the thermostat 434, for example, based on detected usage of one or more components of the HVAC system associated with the thermostat 434. The thermostat 434 can communicate temperature and/or energy monitoring information to or from the control unit 410 and can control the environmental (e.g., temperature) settings based on commands received from the control unit 410.

In some implementations, the thermostat 434 is a dynamically programmable thermostat and can be integrated with the control unit 410. For example, the dynamically programmable thermostat 434 can include the control unit 410, e.g., as an internal component to the dynamically programmable thermostat 434. In addition, the control unit 410 can be a gateway device that communicates with the dynamically programmable thermostat 434. In some implementations, the thermostat 434 is controlled via one or more home automation controls 422.

A module 437 is connected to one or more components of an HVAC system associated with a home, and is configured to control operation of the one or more components of the HVAC system. In some implementations, the module 437 is also configured to monitor energy consumption of the HVAC system components, for example, by directly measuring the energy consumption of the HVAC system components or by estimating the energy usage of the one or more HVAC system components based on detecting usage of components of the HVAC system. The module 437 can communicate energy monitoring information and the state of the HVAC system components to the thermostat 434 and can control the one or more components of the HVAC system based on commands received from the thermostat 434.

In some examples, the system 400 further includes one or more robotic devices 490. The robotic devices 490 may be any type of robots that are capable of moving and taking actions that assist in home monitoring. For example, the robotic devices 490 may include drones that are capable of moving throughout a home based on automated control technology and/or user input control provided by a user. In this example, the drones may be able to fly, roll, walk, or otherwise move about the home. The drones may include helicopter type devices (e.g., quad copters), rolling helicopter type devices (e.g., roller copter devices that can fly and roll along the ground, walls, or ceiling) and land vehicle type devices (e.g., automated cars that drive around a home). In some cases, the robotic devices 490 may be devices that are intended for other purposes and merely associated with the system 400 for use in appropriate circumstances. For instance, a robotic vacuum cleaner device may be associated with the monitoring system 400 as one of the robotic devices 490 and may be controlled to take action responsive to monitoring system events.

In some examples, the robotic devices 490 automatically navigate within a home. In these examples, the robotic devices 490 include sensors and control processors that guide movement of the robotic devices 490 within the home. For instance, the robotic devices 490 may navigate within the home using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 490 may include control processors that process output from the various sensors and control the robotic devices 490 to move along a path that reaches the desired destination and avoids obstacles. In this regard, the control processors detect walls or other obstacles in the home and guide movement of the robotic devices 490 in a manner that avoids the walls and other obstacles.

In addition, the robotic devices 490 may store data that describes attributes of the home. For instance, the robotic devices 490 may store a floorplan and/or a three-dimensional model of the home that enables the robotic devices 490 to navigate the home. During initial configuration, the robotic devices 490 may receive the data describing attributes of the home, determine a frame of reference to the data (e.g., a home or reference location in the home), and navigate the home based on the frame of reference and the data describing attributes of the home. Further, initial configuration of the robotic devices 490 also may include learning of one or more navigation patterns in which a user provides input to control the robotic devices 490 to perform a specific navigation action (e.g., fly to an upstairs bedroom and spin around while capturing video and then return to a home charging base). In this regard, the robotic devices 490 may learn and store the navigation patterns such that the robotic devices 490 may automatically repeat the specific navigation actions upon a later request.

In some examples, the robotic devices 490 may include data capture and recording devices. In these examples, the robotic devices 490 may include one or more cameras, one or more motion sensors, one or more microphones, one or more biometric data collection tools, one or more temperature sensors, one or more humidity sensors, one or more air flow sensors, and/or any other types of sensors that may be useful in capturing monitoring data related to the home and users in the home. The one or more biometric data collection tools may be configured to collect biometric samples of a person in the home with or without contact of the person. For instance, the biometric data collection tools may include a fingerprint scanner, a hair sample collection tool, a skin cell collection tool, and/or any other tool that allows the robotic devices 490 to take and store a biometric sample that can be used to identify the person (e.g., a biometric sample with DNA that can be used for DNA testing).

In some implementations, the robotic devices 490 may include output devices. In these implementations, the robotic devices 490 may include one or more displays, one or more speakers, and/or any type of output devices that allow the robotic devices 490 to communicate information to a nearby user.

The robotic devices 490 also may include a communication module that enables the robotic devices 490 to communicate with the control unit 410, each other, and/or other devices. The communication module may be a wireless communication module that allows the robotic devices 490 to communicate wirelessly. For instance, the communication module may be a Wi-Fi module that enables the robotic devices 490 to communicate over a local wireless network at the home. The communication module further may be a 900 MHz wireless communication module that enables the robotic devices 490 to communicate directly with the control unit 410. Other types of short-range wireless communication protocols, such as Bluetooth, Bluetooth LE, Z-wave, Zigbee, etc., may be used to allow the robotic devices 490 to communicate with other devices in the home. In some implementations, the robotic devices 490 may communicate with each other or with other devices of the system 400 through the network 405.

The robotic devices 490 further may include processor and storage capabilities. The robotic devices 490 may include any suitable processing devices that enable the robotic devices 490 to operate applications and perform the actions described throughout this disclosure. In addition, the robotic devices 490 may include solid-state electronic storage that enables the robotic devices 490 to store applications, configuration data, collected sensor data, and/or any other type of information available to the robotic devices 490.

The robotic devices 490 are associated with one or more charging stations. The charging stations may be located at predefined home base or reference locations in the home. The robotic devices 490 may be configured to navigate to the charging stations after completion of tasks needed to be performed for the monitoring system 400. For instance, after completion of a monitoring operation or upon instruction by the control unit 410, the robotic devices 490 may be configured to automatically fly to and land on one of the charging stations. In this regard, the robotic devices 490 may automatically maintain a fully charged battery in a state in which the robotic devices 490 are ready for use by the monitoring system 400.

The charging stations may be contact based charging stations and/or wireless charging stations. For contact based charging stations, the robotic devices 490 may have readily accessible points of contact that the robotic devices 490 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 490 may charge through a wireless exchange of power. In these cases, the robotic devices 490 need only locate themselves closely enough to the wireless charging stations for the wireless exchange of power to occur. In this regard, the positioning needed to land at a predefined home base or reference location in the home may be less precise than with a contact based charging station. Based on the robotic devices 490 landing at a wireless charging station, the wireless charging station outputs a wireless signal that the robotic devices 490 receive and convert to a power signal that charges a battery maintained on the robotic devices 490.

In some implementations, each of the robotic devices 490 has a corresponding and assigned charging station such that the number of robotic devices 490 equals the number of charging stations. In these implementations, the robotic devices 490 always navigate to the specific charging station assigned to that robotic device. For instance, a first robotic device may always use a first charging station and a second robotic device may always use a second charging station.

In some examples, the robotic devices 490 may share charging stations. For instance, the robotic devices 490 may use one or more community charging stations that are capable of charging multiple robotic devices 490. The community charging station may be configured to charge multiple robotic devices 490 in parallel. The community charging station may be configured to charge multiple robotic devices 490 in serial such that the multiple robotic devices 490 take turns charging and, when fully charged, return to a predefined home base or reference location in the home that is not associated with a charger. The number of community charging stations may be less than the number of robotic devices 490.

In addition, the charging stations may not be assigned to specific robotic devices 490 and may be capable of charging any of the robotic devices 490. In this regard, the robotic devices 490 may use any suitable, unoccupied charging station when not in use. For instance, when one of the robotic devices 490 has completed an operation or is in need of battery charge, the control unit 410 references a stored table of the occupancy status of each charging station and instructs the robotic device to navigate to the nearest charging station that is unoccupied.

The system 400 further includes one or more integrated security devices 480. The one or more integrated security devices may include any type of device used to provide alerts based on received sensor data. For instance, the one or more control units 410 may provide one or more alerts to the one or more integrated security input/output devices 480. Additionally, the one or more control units 410 may receive one or more sensor data from the sensors 420 and determine whether to provide an alert to the one or more integrated security input/output devices 480.

The sensors 420, the home automation controls 422, the camera 430, the thermostat 434, and the integrated security devices 480 may communicate with the controller 412 over communication links 424, 426, 428, 432, 438, and 484. The communication links 424, 426, 428, 432, 438, and 484 may be a wired or wireless data pathway configured to transmit signals from the sensors 420, the home automation controls 422, the camera 430, the thermostat 434, and the integrated security devices 480 to the controller 412. The sensors 420, the home automation controls 422, the camera 430, the thermostat 434, and the integrated security devices 480 may continuously transmit sensed values to the controller 412, periodically transmit sensed values to the controller 412, or transmit sensed values to the controller 412 in response to a change in a sensed value.

The communication links 424, 426, 428, 432, 438, and 484 may include a local network. The sensors 420, the home automation controls 422, the camera 430, the thermostat 434, and the integrated security devices 480, and the controller 412 may exchange data and commands over the local network. The local network may include 802.11 “Wi-Fi” wireless Ethernet (e.g., using low-power Wi-Fi chipsets), Z-Wave, Zigbee, Bluetooth, “Homeplug” or other “Powerline” networks that operate over AC wiring, and a Category 5 (CATS) or Category 6 (CAT6) wired Ethernet network. The local network may be a mesh network constructed based on the devices connected to the mesh network.

The monitoring server 460 is an electronic device configured to provide monitoring services by exchanging electronic communications with the control unit 410, the one or more user devices 440 and 450, and the central alarm station server 470 over the network 405. For example, the monitoring server 460 may be configured to monitor events generated by the control unit 410. In this example, the monitoring server 460 may exchange electronic communications with the network module 414 included in the control unit 410 to receive information regarding events detected by the control unit 410. The monitoring server 460 also may receive information regarding events from the one or more user devices 440 and 450.

In some examples, the monitoring server 460 may route alert data received from the network module 414 or the one or more user devices 440 and 450 to the central alarm station server 470. For example, the monitoring server 460 may transmit the alert data to the central alarm station server 470 over the network 405.

The monitoring server 460 may store sensor and image data received from the monitoring system and perform analysis of sensor and image data received from the monitoring system. Based on the analysis, the monitoring server 460 may communicate with and control aspects of the control unit 410 or the one or more user devices 440 and 450.

The monitoring server 460 may provide various monitoring services to the system 400. For example, the monitoring server 460 may analyze the sensor, image, and other data to determine an activity pattern of a resident of the home monitored by the system 400. In some implementations, the monitoring server 460 may analyze the data for alarm conditions or may determine and perform actions at the home by issuing commands to one or more of the controls 422, possibly through the control unit 410.

The monitoring server 460 can be configured to provide information (e.g., activity patterns) related to one or more residents of the home monitored by the system 400 (e.g., user 108). For example, one or more of the sensors 420, the home automation controls 422, the camera 430, the thermostat 434, and the integrated security devices 480 can collect data related to a resident including location information (e.g., if the resident is home or is not home) and provide location information to the thermostat 434.

The central alarm station server 470 is an electronic device configured to provide alarm monitoring service by exchanging communications with the control unit 410, the one or more user devices 440 and 450, and the monitoring server 460 over the network 405. For example, the central alarm station server 470 may be configured to monitor alerting events generated by the control unit 410. In this example, the central alarm station server 470 may exchange communications with the network module 414 included in the control unit 410 to receive information regarding alerting events detected by the control unit 410. The central alarm station server 470 also may receive information regarding alerting events from the one or more user devices 440 and 450 and/or the monitoring server 460.

The central alarm station server 470 is connected to multiple terminals 472 and 474. The terminals 472 and 474 may be used by operators to process alerting events. For example, the central alarm station server 470 may route alerting data to the terminals 472 and 474 to enable an operator to process the alerting data. The terminals 472 and 474 may include general-purpose computers (e.g., desktop personal computers, workstations, or laptop computers) that are configured to receive alerting data from a server in the central alarm station server 470 and render a display of information based on the alerting data. For instance, the controller 412 may control the network module 414 to transmit, to the central alarm station server 470, alerting data indicating that a sensor 420 detected motion from a motion sensor via the sensors 420. The central alarm station server 470 may receive the alerting data and route the alerting data to the terminal 472 for processing by an operator associated with the terminal 472. The terminal 472 may render a display to the operator that includes information associated with the alerting event (e.g., the lock sensor data, the motion sensor data, the contact sensor data, etc.) and the operator may handle the alerting event based on the displayed information.

In some implementations, the terminals 472 and 474 may be mobile devices or devices designed for a specific function. Although FIG. 4 illustrates two terminals for brevity, actual implementations may include more (and, perhaps, many more) terminals.

The one or more authorized user devices 440 and 450 are devices that host and display user interfaces. For instance, the user device 440 is a mobile device that hosts or runs one or more native applications (e.g., the home monitoring application 442). The user device 440 may be a cellular phone or a non-cellular locally networked device with a display. The user device 440 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 440 may perform functions unrelated to the monitoring system, such as placing personal telephone calls, playing music, playing video, displaying pictures, browsing the Internet, maintaining an electronic calendar, etc.

The user device 440 includes a home monitoring application 452. The home monitoring application 442 refers to a software/firmware program running on the corresponding mobile device that enables the user interface and features described throughout. The user device 440 may load or install the home monitoring application 442 based on data received over a network or data received from local media. The home monitoring application 442 runs on mobile devices platforms, such as iPhone, iPod touch, Blackberry, Google Android, Windows Mobile, etc. The home monitoring application 442 enables the user device 440 to receive and process image and sensor data from the monitoring system.

The user device 440 may be a general-purpose computer (e.g., a desktop personal computer, a workstation, or a laptop computer) that is configured to communicate with the monitoring server 460 and/or the control unit 410 over the network 405. The user device 440 may be configured to display a smart home user interface 452 that is generated by the user device 440 or generated by the monitoring server 460. For example, the user device 440 may be configured to display a user interface (e.g., a web page) provided by the monitoring server 460 that enables a user to perceive images captured by the camera 430 and/or reports related to the monitoring system. Although FIG. 4 illustrates two user devices for brevity, actual implementations may include more (and, perhaps, many more) or fewer user devices.

In some implementations, the one or more user devices 440 and 450 communicate with and receive monitoring system data from the control unit 410 using the communication link 438. For instance, the one or more user devices 440 and 450 may communicate with the control unit 410 using various local wireless protocols such as Wi-Fi, Bluetooth, Z-wave, Zigbee, HomePlug (ethernet over power line), or wired protocols such as Ethernet and USB, to connect the one or more user devices 440 and 450 to local security and automation equipment. The one or more user devices 440 and 450 may connect locally to the monitoring system and its sensors and other devices. The local connection may improve the speed of status and control communications because communicating through the network 405 with a remote server (e.g., the monitoring server 460) may be significantly slower.

Although the one or more user devices 440 and 450 are shown as communicating with the control unit 410, the one or more user devices 440 and 450 may communicate directly with the sensors and other devices controlled by the control unit 410. In some implementations, the one or more user devices 440 and 450 replace the control unit 410 and perform the functions of the control unit 410 for local monitoring and long range/offsite communication.

In other implementations, the one or more user devices 440 and 450 receive monitoring system data captured by the control unit 410 through the network 405. The one or more user devices 440, 450 may receive the data from the control unit 410 through the network 405 or the monitoring server 460 may relay data received from the control unit 410 to the one or more user devices 440 and 450 through the network 405. In this regard, the monitoring server 460 may facilitate communication between the one or more user devices 440 and 450 and the monitoring system.

In some implementations, the one or more user devices 440 and 450 may be configured to switch whether the one or more user devices 440 and 450 communicate with the control unit 410 directly (e.g., through link 438) or through the monitoring server 460 (e.g., through network 405) based on a location of the one or more user devices 440 and 450. For instance, when the one or more user devices 440 and 450 are located close to the control unit 410 and in range to communicate directly with the control unit 410, the one or more user devices 440 and 450 use direct communication. When the one or more user devices 440 and 450 are located far from the control unit 410 and not in range to communicate directly with the control unit 410, the one or more user devices 440 and 450 use communication through the monitoring server 460.

Although the one or more user devices 440 and 450 are shown as being connected to the network 405, in some implementations, the one or more user devices 440 and 450 are not connected to the network 405. In these implementations, the one or more user devices 440 and 450 communicate directly with one or more of the monitoring system components and no network (e.g., Internet) connection or reliance on remote servers is needed.

In some implementations, the one or more user devices 440 and 450 are used in conjunction with only local sensors and/or local devices in a house. In these implementations, the system 400 includes the one or more user devices 440 and 450, the sensors 420, the home automation controls 422, the camera 430, and the robotic devices 490. The one or more user devices 440 and 450 receive data directly from the sensors 420, the home automation controls 422, the camera 430, and the robotic devices 490, and sends data directly to the sensors 420, the home automation controls 422, the camera 430, and the robotic devices 490. The one or more user devices 440, 450 provide the appropriate interfaces/processing to provide visual surveillance and reporting.

In other implementations, the system 400 further includes network 405 and the sensors 420, the home automation controls 422, the camera 430, the thermostat 434, and the robotic devices 490, and are configured to communicate sensor and image data to the one or more user devices 440 and 450 over network 405 (e.g., the Internet, cellular network, etc.). In yet another implementation, the sensors 420, the home automation controls 422, the camera 430, the thermostat 434, and the robotic devices 490 (or a component, such as a bridge/router) are intelligent enough to change the communication pathway from a direct local pathway when the one or more user devices 440 and 450 are in close physical proximity to the sensors 420, the home automation controls 422, the camera 430, the thermostat 434, and the robotic devices 490 to a pathway over network 405 when the one or more user devices 440 and 450 are farther from the sensors 420, the home automation controls 422, the camera 430, the thermostat 434, and the robotic devices 490.

In some examples, the system leverages GPS information from the one or more user devices 440 and 450 to determine whether the one or more user devices 440 and 450 are close enough to the sensors 420, the home automation controls 422, the camera 430, the thermostat 434, and the robotic devices 490 to use the direct local pathway or whether the one or more user devices 440 and 450 are far enough from the sensors 420, the home automation controls 422, the camera 430, the thermostat 434, and the robotic devices 490 that the pathway over network 405 is required.

In other examples, the system leverages status communications (e.g., pinging) between the one or more user devices 440 and 450 and the sensors 420, the home automation controls 422, the camera 430, the thermostat 434, and the robotic devices 490 to determine whether communication using the direct local pathway is possible. If communication using the direct local pathway is possible, the one or more user devices 440 and 450 communicate with the sensors 420, the home automation controls 422, the camera 430, the thermostat 434, and the robotic devices 490 using the direct local pathway. If communication using the direct local pathway is not possible, the one or more user devices 440 and 450 communicate with the sensors 420, the home automation controls 422, the camera 430, the thermostat 434, and the robotic devices 490 using the pathway over network 405.

In some implementations, the system 400 provides end users with access to images captured by the camera 430 to aid in decision making. The system 400 may transmit the images captured by the camera 430 over a wireless WAN network to the user devices 440 and 450. Because transmission over a wireless WAN network may be relatively expensive, the system 400 can use several techniques to reduce costs while providing access to significant levels of useful visual information (e.g., compressing data, down-sampling data, sending data only over inexpensive LAN connections, or other techniques).

In some implementations, a state of the monitoring system and other events sensed by the monitoring system may be used to enable/disable video/image recording devices (e.g., the camera 430). In these implementations, the camera 430 may be set to capture images on a periodic basis when the alarm system is armed in an “away” state, but set not to capture images when the alarm system is armed in a “home” state or disarmed. In addition, the camera 430 may be triggered to begin capturing images when the alarm system detects an event, such as an alarm event, a door-opening event for a door that leads to an area within a field of view of the camera 430, or motion in the area within the field of view of the camera 430. In other implementations, the camera 430 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device.

Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A method comprising:
obtaining images of a scene from a camera;
determining that an event is likely to occur at a particular time based on the obtained images;
in response to determining that the event is likely to occur at the particular time based on the obtained images, generating an instruction that triggers a user device to provide an alert to a user of the user device at the particular time; and
providing the instruction to the user device.

2. The method of claim 1, wherein the instruction that triggers the user device to provide the alert at the particular time includes alert data, the alert data comprising at least one of:
the obtained images of the scene;
notification text to be displayed by the user device;
a classification of an object identified in the images;
the particular time that the event is likely to occur; or
a classification of the event.

3. The method of claim 2, wherein providing the instruction to the user device includes providing, to the user device, the alert data and an instruction to pre-cache the alert data until the particular time.

4. The method of claim 1, comprising providing, to the user device, video of the scene captured by the camera during a first programmed time duration before the particular time and during a second programmed time duration after the particular time.

5. The method of claim 4, wherein:
the images of the scene are obtained at a first time, and
the first programmed time duration includes:
a particular number of seconds prior to the first time, and
a time duration between the first time and the particular time.

6. The method of claim 4, wherein the second programmed time duration includes a particular number of seconds after the particular time.

7. The method of claim 1, comprising:
providing, to the user device, a live video stream of the scene.

8. The method of claim 1, comprising:
obtaining additional images of the scene from the camera;
determining, based on the additional images, that the event is likely to occur at a second time, the second time being earlier than the particular time by greater than a programmed time deviation;
based on determining that the event is likely to occur at the second time, generating an updated instruction that triggers the user device to provide the alert at the second time, and instructs the user device not to provide the alert at the particular time; and
providing the updated instruction to the user device.

9. The method of claim 1, comprising:
obtaining additional images of the scene from the camera;
determining, based on the additional images, that the event is likely to occur at a third time, the third time being later than the particular time by greater than a programmed time deviation;
based on determining that the event is likely to occur at the third time, generating an updated instruction that triggers the user device to provide the alert at the third time, and instructs the user device not to provide the alert at the particular time; and
providing the updated instruction to the user device.

10. The method of claim 9, comprising:
after providing the updated instruction to the user device, obtaining second additional images from the camera;
verifying, based on the second additional images, that the event is likely to occur within a programmed time deviation from the third time; and
based on verifying that the event is likely to occur within the programmed time deviation the third time, allowing the user device to provide the alert at the third time by providing no additional instruction to the user device.

11. The method of claim 1, comprising:
obtaining additional images of the scene from the camera;
determining, based on the additional images, that the event is not likely to occur;
based on determining that the event is not likely to occur, generating an updated instruction that instructs the user device to cancel providing the alert at the particular time; and
providing the updated instruction to the user device.

12. The method of claim 1, comprising:
obtaining additional images of the scene from the camera;
determining, based on the additional images, that the event occurred within a programmed time deviation from the particular time; and
based on determining that the event occurred within the programmed time deviation from the particular time, allowing the user device to provide the alert by providing no additional instruction to the user device.

13. The method of claim 12, wherein allowing the user device to provide the alert comprises not providing an instruction to the user device to cancel providing the alert at the particular time.

14. The method of claim 1, wherein determining that the event is likely to occur at the particular time comprises determining that a confidence that the event will occur at the particular time exceeds a threshold confidence.

15. The method of claim 1, wherein the event comprises at least one of an object crossing a virtual line crossing, an object entering an area of interest, an object being present in an area of interest for greater than a threshold period of time, or an object entering an area of interest greater than a threshold number of times.

16. The method of claim 1, wherein determining that an event is likely to occur at a particular time based on the obtained images comprises:
determining a position, speed, and direction of an object in the obtained images;
determining a position of an area of interest in the obtained images; and
based on the position, speed, and direction of the object and based on the position of the area of interest, determining that the object is likely to enter the area of interest at the particular time.

17. A monitoring system for monitoring a property, the monitoring system comprising one or more computers configured to perform operations comprising:
obtaining images of a scene from a camera;
determining that an event is likely to occur at a particular time based on the obtained images;
in response to determining that the event is likely to occur at the particular time based on the obtained images, generating an instruction that triggers a user device to provide an alert to a user of the user device at the particular time; and
providing the instruction to the user device.

18. The monitoring system of claim 17, wherein the instruction that triggers the user device to provide the alert at the particular time includes alert data, the alert data comprising at least one of:
the obtained images of the scene;
notification text to be displayed by the user device;
a classification of an object identified in the images;
the particular time that the event is likely to occur; or
a classification of the event.

19. The monitoring system of claim 18, wherein providing the instruction to the user device includes providing, to the user device, the alert data and an instruction to pre-cache the alert data until the particular time.

20. A non-transitory computer-readable medium storing software comprising instructions executable by one or more computers which, upon such execution, cause the one or more computers to perform operations comprising:
obtaining images of a scene from a camera;
determining that an event is likely to occur at a particular time based on the obtained images;
in response to determining that the event is likely to occur at the particular time based on the obtained images, generating an instruction that triggers a user device to provide an alert to a user of the user device at the particular time; and
providing the instruction to the user device.
